(19) United States
(12) Patent Application Publication
(10) Pub. No.: US 2024/0339053 A1
(43) Pub. Date: Oct. 10, 2024

(54) SAFE COVERING INCLUDING OPTICAL VIDEO CLOAKING AND METHOD FOR USING SAME

(71) Applicant: Joshua P. Frank, O'Fallon, MO (US)

(72) Inventor: Joshua P. Frank, O'Fallon, MO (US)

(21) Appl. No.: 18/131,822

(22) Filed: Apr. 6, 2023

(51) Int. Cl. G09F 7/18

(52) U.S. Cl. CPC G09F 7/18; E05G 1/00; G09F 2007/1852

(57) ABSTRACT

A safe concealing cloak that includes portions that cover the main door and may cover portions of the sides and top. The safe concealing cloak may include an impression of a bookshelf, as well as impressions of books and three-dimensional items on the impression of a bookshelf. Typically, the safe concealing cloak will use shading and other devices to provide a sense of depth to the bookshelf and related impressions such that the cloaked safe will appear as a bookshelf having depth to an observer.

### BACKGROUND OF THE INVENTION

### Field of the Invention

The present disclosure relates to systems and methods for concealing a safe while the safe is located in an area accessible to third parties and cameras. Specifically, the present disclosure relates to a safe concealing cloak that may be able to conceal a safe from an observer, especially one that is viewing through a camera.

### Description of the Related Art

Safes have been in use in American homes and businesses for a long time. Rather large safes, such as a gun safe, are typically huge metal boxes that may be secured closed by their users to store valuables of practically any kind. Such safes tend to be rectangular in shape, having large, flat surfaces on all sides. FIG. 1 is a depiction of a typical safe (100). One of the flat surfaces is typically broken up by a door (3), which door (3) typically features various locking mechanisms (7) thereon that jut out from the otherwise substantially flat surface. This side is often referred to as the “front” of the safe. The other sides (5) are each typically substantially planar.

The metal body of a safe may protect the contents therein from third-party access and from environmental dangers including fires. The thick metal frame may act as a barrier to entry to the safe for any potential thief, thereby by making it more difficult to take possession of or steal the items locked therein. As a result of this purpose, safes are typically big, heavy, and consistently shaped. At least due to these attributes, safes tend to be conspicuous. Moreover, the mere presence of a safe may signal to observers that something valuable is likely to be stored within. Thus, the mere presence of a safe may cause the safe and its contents to become a target for thieves if the safe is observed or otherwise discovered by someone with ill intent. Thus, in some senses, the use of a safe can both improve and reduce security.

Due in part to their usefulness, safes (100) have may applications, and as a result, may be located in a variety of places, including businesses and homes. In such settings, it may be impractical or impossible to locate the safe (100) in an area of the relevant building that is off limits to third-parties (also known as “observers” herein). For example, in a given home, it may be impractical or impossible to locate a safe in the basement or any upper floor due to their size and weight. Further, safes (100) may not fit into many spaces due to their large size. Such a gun safe (100) will not fit into most walls, for example. In many cases, it may be most practical for the user of the safe (100) to store the safe (100) in a home office on the ground level of the home.

In such a location, however, the safe (100) may be visible to, and therefore recognizable by, passersby through a window. Further, guests within the home may be able to view the safe (100) while inside the home. Moreover, with today's uptick in the availability of cameras, such as cellphone cameras and webcams for computers, such a safe (100) may be visible to those viewing video from such a camera. For example, where the safe (100) is stored in a home office, there may also be a computer with a webcam in the same room. In such a case, this proximity to cameras may increase the likelihood that a person viewing the video feed from such a camera is able to identify the safe (100) within the home office.

In some cases, users of the safe (100) may decide to conceal the safe (100) to prevent or reduce the likelihood of the safe (100) being viewed by third parties, and then subsequently identified to be a safe. Complete concealment of a safe (100), however, may be impractical or impossible. For example, due to the typical safe's (100) considerable size and volume, a safe (100) may still be recognizable even when covered by something else.

In some cases, safe users have attempted to conceal a safe (100) by draping material over the entire body of the safe (100), wherein the material is patterned to look like a wooden cupboard. However, such coverings tend to have limited success due to their awkward appearance and limited ability to resemble an actual cupboard. One issue with these cupboard-like coverings is that these prior attempts at concealment were always two-dimensional in their appearance, which appearances were poor designs for concealment. Any ruffle, wrinkle, or wrong angle may betray the hidden nature of the safe. Another issue with the cupboard-like coverings is that such cupboards typically are formed of specific materials, such as a wood material featuring a particular grain and a particular color. The issue may be that such furniture is often matched to other furniture in the same vicinity. It can be very difficult, if not impossible, to provide such matching in a non-customized, printed safe covering.

Further, such covers tended to be bulky and inconvenient to take off and put on. This is especially true because many such covers require an interior frame so that the two-dimensional image on the cover is not altered by contacting the locking mechanisms. Instead, the frame may extend the cover beyond the locking mechanisms of the safe (100). And all of these issues are exacerbated by the now ubiquitous nature of videoconferencing.

Videoconferencing has existed for a long time, but its popularity skyrocketed during the Covid-19 pandemic in 2020. During that time, a majority of workers in the United States, and much of the world, were forced to work from home. At the same time, businesses endeavored to find ways to stay in touch with employees and clients. This led to a meteoric rise in the prevalence of videoconferencing. Today, videoconferencing remains popular, even outside of the work-from-home environment. As a result, videoconferencing equipment is also ubiquitous. And further, rooms and areas that were previously kept at least mostly private may now often be under the purview of observers through a camera. Prior to the videoconferencing boom, people were more likely to meet in a meeting room. Now, videoconferences often occur in personal or home offices, or in other areas that were previously not typical locations for meetings. As a result, many safes are now at risk of being noticed by attendees to videoconferencing.

Accordingly, there is a need in the art for a system for concealing a safe (100) within a home or business, wherein the system is easy to use and capable of providing a realistic appearance to observers. This is especially true for ubiquitous observers using cameras to observe the location of the safe (100).

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of the above and other problems in the art, described herein are safe concealing cloaks that include portions that cover the main door and may cover portions of the sides and top. Such a safe concealing cloak may include an impression of a bookshelf, as well as impressions of books and three-dimensional items on the impression of a bookshelf. Typically, the safe concealing cloak will use shading and other devices to provide a sense of depth to the bookshelf and related impressions such that the cloaked safe will appear as a bookshelf having depth to an observer.

In an embodiment, there is described a safe concealing cloak comprising: a main body having a bookshelf impression, at least one book impression and at least one three-dimensional object impression; a first side portion integrated with the main body; a second side portion integrated with the main body; and a top portion integrated with the main body; wherein the bookshelf impression, the at least one book impression, and the at least one three-dimensional object impression are all configured to provide an observer with a sense of depth when viewed from a plurality of perspectives.

In an embodiment, the safe concealing cloak further comprises a plurality of magnets configured to attach the safe concealing cloak to a related safe.

In an embodiment of the safe concealing cloak, each magnet of the plurality of magnets is integrated into the safe concealing cloak.

In an embodiment of the safe concealing cloak, the plurality of magnets is at least eight magnets.

In an embodiment of the safe concealing cloak, the main body comprises a polyester material.

In an embodiment of the safe concealing cloak, the bookshelf impression, the at least one book impression, and the at least one three-dimensional object impression are all configured so that shading around each provides an overall sense of depth for the safe concealing cloak.

There is also described herein, in an embodiment, a method of concealing a safe, the method comprising: providing a safe; providing safe concealing cloak comprising: a main body having a bookshelf impression, at least one book impression and at least one three-dimensional object impression; a first side portion integrated with the main body; a second side portion integrated with the main body; and a top portion integrated with the main body; wherein the bookshelf impression, the at least one book impression, and the at least one three-dimensional object impression are all configured to provide an observer with a sense of depth when viewed from a plurality of perspectives; and attaching the safe concealing cloak to the safe by covering a door portion of the safe with the safe concealing cloak using magnets.

### BRIEF DESCRIPTION OF THE DRAWINGS

FIG. 1 depicts a perspective view of a typical safe.

FIG. 2 depicts another typical safe being partially covered with a safe concealing cloak in accordance with this application.

FIG. 3 depicts another view of the safe concealing cloak depicted in FIG. 2.

FIG. 4 depicts a close up view of a portion of the top row of the bookshelf image depicted in FIG. 3.

FIG. 5 depicts the safe and safe concealing cloak of FIG. 1 in a home office setting.

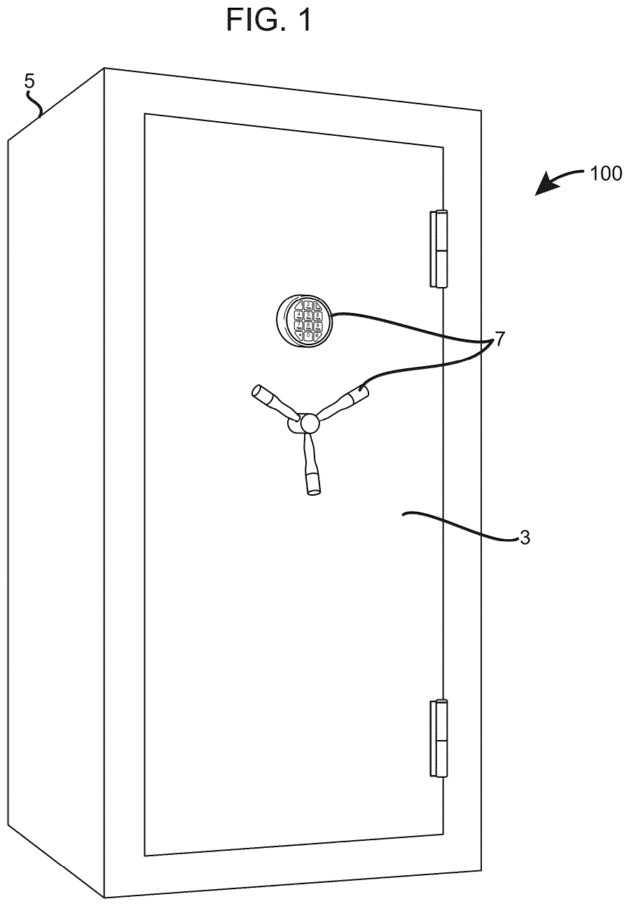

### DETAILED DESCRIPTION OF PREFERRED EMBODIMENTS

The following detailed description and disclosure illustrates by way of example and not by way of limitation. This description enables one skilled in the art to make and use the disclosed systems and methods, and describes several embodiments, adaptations, variations, alternatives, and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

There is described herein, among other things, systems and methods for concealing a safe or the like from being easily recognizable to observers who are either present with the safe or are viewing the same via a camera. Specifically, the systems and methods herein may conceal a safe by using a concealing cloak to make the safe appear to be a bookshelf having thereon a number of books or items and by providing a sense of depth to the shelving and objects that appear to be thereon. Further, some embodiments of a safe concealing cloak may be capable of attaching to a safe in a convenient and readily accessible manner.

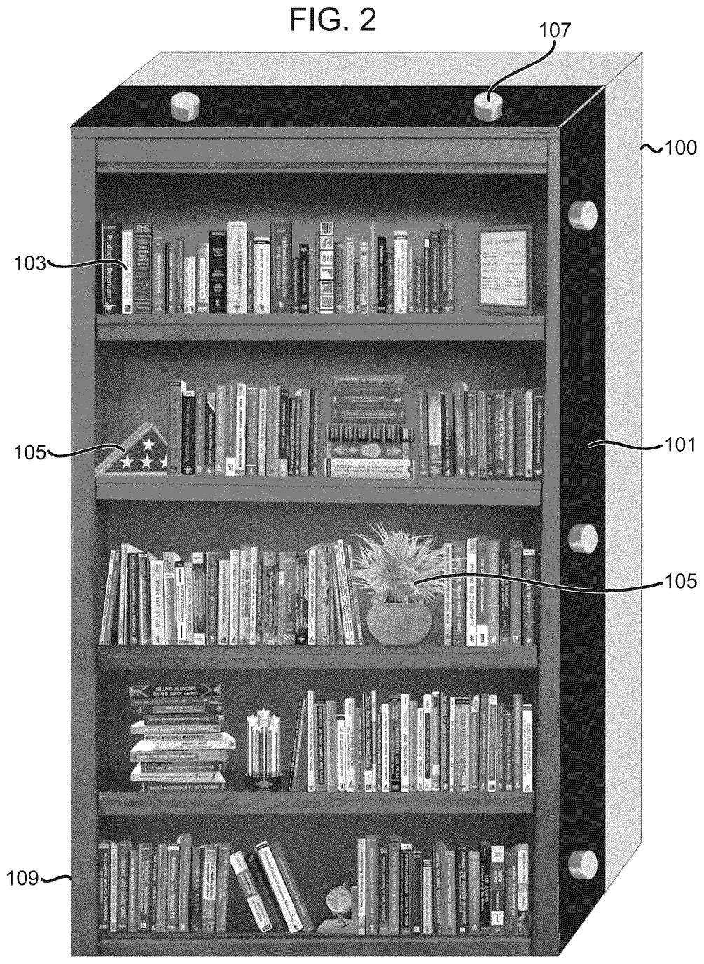

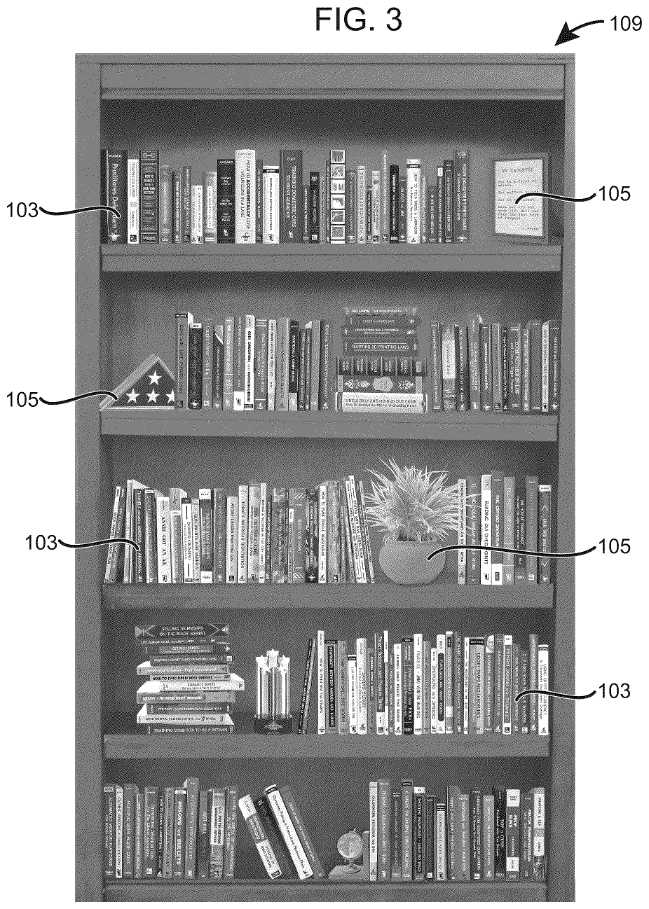

FIGS. 2 and 3 depict a safe (100) being partially covered by an embodiment of a safe concealing cloak (101). FIG. 5 depicts the safe (100) located in a home office setting. The safe concealing cloak (101) includes a number of features that may allow the related safe (100) to go unnoticed by persons viewing the safe in-person or though a camera. For example, the safe concealing cloak (101) may include an overall impression of a bookshelf (109), one or more book impressions (103), or one or more three-dimensional object impressions (105). These elements may work together to create an illusion of depth in the image on the safe concealing cloak (101). This illusion of depth may create an impression of a real bookshelf even when viewed from a number of different angles and even if the cloak's main face is not planar due to it passing over, for example, locking mechanisms on the safe. Without limiting this application to any theory of operation, such an illusion of depth may be produced by a combination of presenting images of objects known to have depth with the use of multiple shading features, together with other devices known to persons of ordinary skill in the art.

Further, the use of shading, especially matte black shading and regions of matte black, may assist the safe concealing cloak (101) in providing an illusion of depth and overall concealment. The illusion of depth may be especially applicable to cameras. In any case, this illusion may be provided because the depth within a typical bookshelf may be that of shadows, or the absence of light. Unlike a closed cupboard, where one would expect to see the entirety of the material comprising the doors of a cupboard when viewing the cupboard from the front, a book shelf does not present an entire front filled with pattern or material. Instead, bookshelves may often be characterized as having significant negative space, wherein, depending on the lighting, much of the negative space itself is viewed as shadows or blackness, due to the lack of reflected light from regions not possessed by any book. As such, an observer viewing a bookshelf does not expect to see a solid surface of patterned material. Instead, significant black-seeming negative space is expected around the books and objects on the shelves of the bookcase.

As would be understood by a person of ordinary skill in the art, this ability to effectively create an illusion of depth is especially true where the safe concealing cloak (101) is being observed through a camera, as cameras typically have a fixed point of view and depth of field created by the lens system. Cameras tend to have a limited depth of field, and in any case, cameras create a two-dimensional representation of the three-dimensional world. This translation flattens space, automatically creating an image that itself merely provides an impression of depth because a two-dimensional image has no depth. In this context, the use of familiar images and varied shading patterns may produce the impression of a bookshelf having depth from a number of different perspectives. In this way, or by other means, the safe concealing cloak (101) may be able to cloak and conceal a related safe (100). The safe concealing cloak (101) will typically be more effective when the camera-at-issue is further from the safe concealing cloak (101), and the safe concealing cloak (101) may have a minimum effective viewing distance. In some cases, such a minimum effective viewing distance may be about 10 feet.

The safe concealing cloak (101) in the embodiment depicted in FIG. 2 is made of a polyester material. In other embodiments, any material may be used. The fabric may be died or colorized using any known method. In a typical embodiment, the safe concealing cloak (101) may be died or colorized using sublimation ink printing. Such a material and printing combination may be used to take advantage of the non-reflective and non-shiny appearance of the combined techniques.

In the embodiment depicted in FIG. 2, the bookshelf impression (109) may appear to be made of wood and may include any number of shelf impressions thereon. As can be seen in FIG. 2, the depicted embodiment has a bookshelf impression (109) including five shelf impressions that extend from one side of the safe (100) to the other. More or less shelf impressions may be used, as well as vertical divisions. And the shelf impressions may mimic the appearance of any material known to be used to produce bookshelves. Typically, full-length shelves will be used to maximize the impression of a typical bookshelf for any observers. The apparent height of each shelf impression will tend to be the same as a typical bookshelf, ranging between a quarter of an inch and two inches in height. Overall, the apparent construction of the bookshelf impression (109) may be any that renders an overall appearance of a real-world bookshelf.

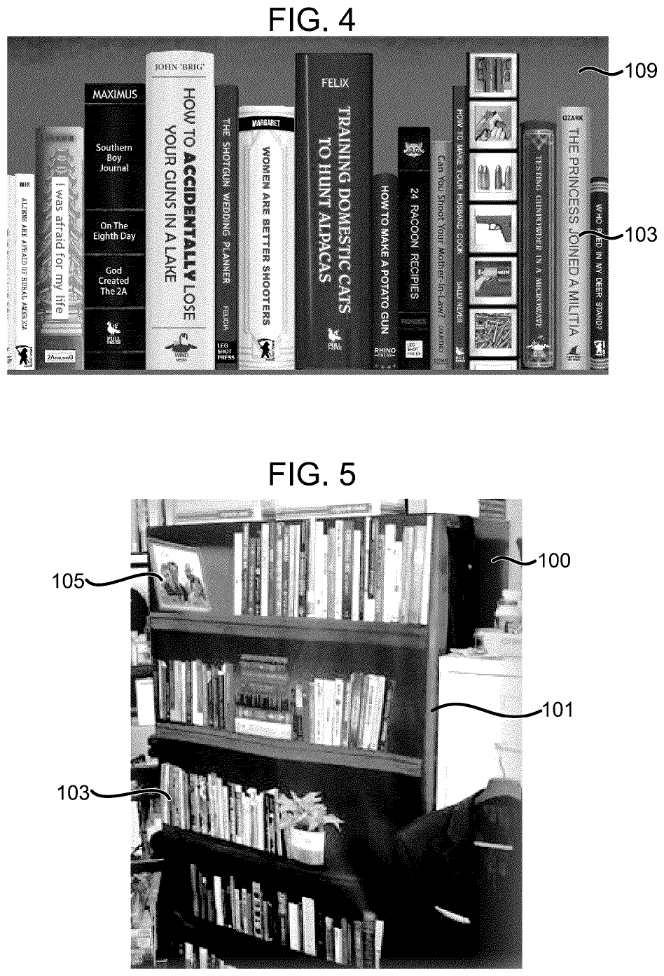

As stated above, each shelf impression may include a number of book impressions (103) thereon, each of which may resemble a book or a number of books stored on a shelf, and a number of other three-dimensional object impressions (105), each of which may resemble a three-dimensional object stored on a shelf. A close up view of some book impressions (103) are shown in FIG. 4. In general, each book impression (103) is typically modeled from real-world books.

Each book impression (103) may include the appearance of one or more books stored on a shelf and having the binding end of each book facing away from the bookshelf impression (109). In many examples, the binding end of the relevant book impression (103) may have a book title, author name, or other information located thereon. In some embodiments, such information may be and may also be designed to provide for “themed” or even slightly humorous interpretation as the text will generally be too small to be seen and read via video camera in the same room which can see the safe concealing cloak (101). The book impressions (103) themselves may be depicted as having any size, color, or other distinguishing feature, and will typically vary from book to book. In the embodiment depicted in FIG. 2, the safe concealing cloak (101) includes book impressions (103) showing over 170 books in total.

Each three-dimensional object impression (105) is typically modeled from one or more real-world three-dimensional objects. For example, each three-dimensional object impression (105) may include the appearance of a three-dimensional object stored on a shelf. The three-dimensional object represented may be any object that may typically be stored on a bookshelf, including without limitation a placard, a picture frame, a folded flag, a potted plant, an award, a bookend, and a model train. The three-dimensional object impressions (103) themselves may be depicted as having any size, color, or other distinguishing feature, and will typically vary from object to object. In any case, each book impression (103) and three-dimensional object impression may be configured to work with the bookshelf impression (109) and any other book impressions (103) or three-dimensional objects (105) to create the overall impression of a real-world bookshelf. In an embodiment, the three-dimensional objects may be custom generated for the user of the safe concealing cloak (101) to further obscure that the cloak exists. For example, a picture in a picture frame may be of individuals in the user's family and an award may be modeled on an actual award the user received.

As can be seen in FIG. 2, the safe concealing cloak (101) may be configured to cover the door (3) and lock mechanisms of the safe (100). As shown in the embodiment depicted in FIG. 2, the safe concealing cloak (101) may also be configured to cover portions of the sides and top of the safe (100). The amount of coverage may vary between embodiments between no coverage and complete coverage. In the embodiment depicted in FIG. 2, the safe concealing cloak (101) only partially covers the sides and top of the safe (100), wherein the partial coverage is about half. In some embodiments, the covering on the sides extends for six inches, or more than six inches.

The safe concealing cloak (101) may be attached to the safe (100) using one or more magnets (107). In the embodiment depicted in FIG. 2, the safe concealing cloak (101) may be attached to the safe (100) using eight magnets (107): three magnets (107) for each side and two magnets (107) on top. By adjusting the locations of the magnets (107) and the tension across the safe concealing cloak (101), the safe concealing cloak (101) may be properly positioned to provide concealment. In other embodiments, more or less magnets (107) may be used. In some embodiments, the magnets (107) may be integrated into the safe concealing cloak (101). For example, the safe concealing cloak (101) may have pockets or other portions for holding one or more magnets (107), with at least some of the pockets or portions being positioned near the periphery of the safe concealing cloak (101). The arrangement of the magnets (107) may be any arrangement. In the embodiment depicted in FIG. 2, the magnets (107) are spaced in a manner so as to distribute the force of holding up and maintaining the safe concealing cloak (101) relatively evenly between each magnet (107). The magnets (107) used may be any magnets, having any size. In some embodiments, the magnets (107) may be 0.75 inches in diameter. It should be recognized that while it is typically preferable for the front side of the safe concealing cloak (101) to be positioned as planar as possible, the depth concealing nature of the cloak (101) will typically serve to conceal slight bends or transitions allowing the cloak (101) to more easily be placed over an uneven surface, such as where locking mechanisms extend from the safe (100).

The safe (100) may be any safe, such as a gun safe or fireproof safe. Such a safe (100) will typically be relatively large in size and relatively heavy in weight. For example, a typical safe (100) may be about 30 inches wide, about 60 inches in height, and about 28 inches in depth. Such a safe (100) will typically be formed of steel and other materials and weigh between about 800 and about 1000 pounds when empty of any storage contents. In some embodiments, the safe (100) may have other dimensions and weights. In yet other embodiments, the safe (100) may be made of any material or combination of materials.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “flat” or any of the polyhedral forms contemplated herein are purely geometric constructs and no real-world component or relationship is truly such a shape in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers on any such mathematical term to include a range of variations from the literal geometric meaning of the term in view of these and other considerations.

1. A safe concealing cloak comprising:
a main body having a bookshelf impression, at least one book impression and at least one three-dimensional object impression;
a first side portion integrated with the main body;
a second side portion integrated with the main body; and
a top portion integrated with the main body;
wherein the bookshelf impression, the at least one book impression, and the at least one three-dimensional object impression are all configured to provide an observer with a sense of depth when viewed from a plurality of perspectives.

2. The safe concealing cloak of claim 1 further comprising a plurality of magnets configured to attach the safe concealing cloak to a related safe.

3. The safe concealing cloak of claim 2, wherein each magnet of the plurality of magnets is integrated into the safe concealing cloak.

4. The safe concealing cloak of claim 3, wherein the plurality of magnets is at least eight magnets.

5. The safe concealing cloak of claim 1, wherein the main body comprises a polyester material.

6. The safe concealing cloak of claim 1, wherein the bookshelf impression, the at least one book impression, and the at least one three-dimensional object impression are all configured so that shading around each provides an overall sense of depth for the safe concealing cloak.

7. A method of concealing a safe, the method comprising:
providing a safe;
providing safe concealing cloak comprising:
a main body having a bookshelf impression, at least one book impression and at least one three-dimensional object impression;
a first side portion integrated with the main body;
a second side portion integrated with the main body; and
a top portion integrated with the main body;
wherein the bookshelf impression, the at least one book impression, and the at least one three-dimensional object impression are all configured to provide an observer with a sense of depth when viewed from a plurality of perspectives; and
attaching the safe concealing cloak to the safe by covering a door portion of the safe with the safe concealing cloak using magnets.
